(19) United States
(12) Patent Application Publication
(10) Pub. No.: US 2010/0029300 A1
(43) Pub. Date: Feb. 4, 2010

(54) METHOD FOR INQUIRING REAL-TIME TRAVEL-RELATED INFORMATION USING A MOBILE COMMUNICATION DEVICE

(75) Inventor: Wen-Chi Chen, Hsinchu City (TW)

Correspondence Address: Muncy, Geissler, Olds & Lowe, PLLC, P.O. BOX 1364, FAIRFAX, VA, 22038-1364, US

(73) Assignee: ARIMA COMMUNICATIONS CORP.

(21) Appl. No.: 12/182,539

(22) Filed: Jul. 30, 2008

(51) Int. Cl. H04Q 7/20

(52) U.S. Cl. 455/456.3

(57) ABSTRACT

In a method for inquiring real-time travel-related information using a mobile communication device having satellite navigation software installed therein, the following are included: the mobile communication device sending a short message containing target GPS coordinates of a destination to a travel information server at an operation and maintenance center (OMC) of a mobile phone system; and the travel information server calculating based on the target GPS coordinates to locate a target mobile phone BTS that is closest to the destination, obtaining real-time weather information dynamically collected by weather monitors at the target mobile phone BTS, and transmitting the weather information along with separately collected visitor density information in connection with the destination to the mobile communication device.

### FIELD OF THE INVENTION

The present invention relates to a method for inquiring real-time travel-related information using a mobile communication device having satellite navigation software installed therein. With the satellite navigation software, the mobile communication device is able to send a short message containing target GPS coordinates of a destination, so as to obtain real-time weather information dynamically collected by weather monitors at a mobile phone base transceiver station (BTS) closest to the destination.

### BACKGROUND OF THE INVENTION

A mobile communication device, such as a mobile phone, has become a prerequisite personal portable communication device now. In general, a mobile communication system provider would provide paid advertisement information to mobile communication device users. The advertisement information is usually previously loaded on an advertisement server platform of the system provider. Such advertisement information is static and not real-time.

Recently, some mobile communication system providers have started offering dynamic and real-time advertisement information in a different manner. When a mobile communication device is located near a certain mobile phone base transceiver station (BTS), the advertisement platform of the system provider would, via the mobile communication device's registered BTS, passively or actively broadcast advertisement information in connection with nearby areas to the mobile communication device, such as discount offered by a restaurant near the registered base station, a bargain sale at a nearby department store, etc. The above method has a disadvantage that the mobile communication device must first locate in a specific area before obtaining such related information.

Therefore, both of the above two conventional methods fail to provide the mobile communication device user with dynamic and real-time information about a remote place. That is, the mobile communication device user is not able to get real-time local information via the mobile communication device before the user reaches at the area.

For example, a mobile communication device user is currently at place A, and plans to visit a remote place B. When the user wants to use the mobile communication device to inquire weather condition of the remote place B, the user would generally link the mobile communication device with Internet and visit a weather website, or inquire the registered mobile phone BTS about the weather condition of the remote place B. However, neither of the two methods can provide the user with real-time information about the weather condition of the remote place B. Moreover, the weather information is usually uniformly released by a national weather bureau. Such weather information is general and not real-time because there is only limited number of weather monitoring stations. As a result, the weather information provided by the weather bureau is rough without relatively accurate local weather information.

In addition to weather information, a traveler would also like to know information about the air quality, temperature, humidity, wind speed, wind direction, rain capacity, ultraviolet intensity, etc. of a remote place. Moreover, information about the number of visitors at the remote place is also very important to the traveler in deciding a travel plan.

### SUMMARY OF THE INVENTION

A primary object of the present invention is to provide a method for inquiring real-time travel-related information in connection with a destination using a mobile communication device.

To achieve the above and other objects, a mobile communication device having satellite navigation software installed therein is used in the method for inquiring real-time travel-related information according to the present invention. The method includes the following steps: the mobile communication device sending a short message containing target GPS coordinates of a destination to a travel information server at an operation and maintenance center (OMC) of a mobile phone system; and the travel information server calculating based on the target GPS coordinates to locate a target mobile phone BTS that is closest to the destination, obtaining real-time weather information dynamically collected by weather monitors at the target mobile phone BTS, and transmitting the weather information along with separately collected visitor density information in connection with the destination to the mobile communication device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a mobile communication device used in the present invention;

FIG. 2 is a flow chart showing the steps included in the method for inquiring real-time travel-related information using a mobile communication device according to the present invention; and

FIG. 3 is a diagram showing the configuration of a mobile phone system applied in the present invention.

### DETAILED DESCRIPTION OF THE PREFERRED EMBODIMENTS

The present invention relates to a method for inquiring real-time travel-related information using a mobile communication device.

The method generally includes the following steps:
1. Prepare a mobile communication device having a GPS module and satellite navigation software installed therein;
2. The mobile communication device runs the satellite navigation software to transmit a short message containing target GPS coordinates of a destination. Via a registered base transceiver station (BTS) of the mobile communication device, the short message is sent to a travel information server at an operation and maintenance center (OMC) of a mobile phone system that provides short message service (SMS);
3. The travel information server receives the SMS short message containing the target GPS coordinates of the destination, calculates based on the received target GPS coordinates to locate a target mobile phone base transceiver station (BTS) that is closest to the destination, and obtains real-time weather data dynamically collected by weather monitors at the target mobile phone BTS. The weather monitors at the target mobile phone BTS are able to constantly monitor and collect real-time data in connection with local weather, including air quality, temperature, humidity, wind speed, wind direction, rain capacity, ultraviolet intensity, etc., for providing to the travel information server;
4. The travel information server also obtains from the OMC of the mobile phone system data about visitor flow at the destination collected by the target mobile phone BTS, such as the average number of mobile phones registered at the target mobile phone BTS, the current number of mobile phones registered at the target mobile phone BTS, the average visitor flow at the destination, the current visitor flow at the destination, etc., for use as real-time information about local visitor density; and
5. The travel information server utilizes the SMS to transmit an SMS short message containing travel-related information, including local weather information and local visitor density information, to the mobile communication device.

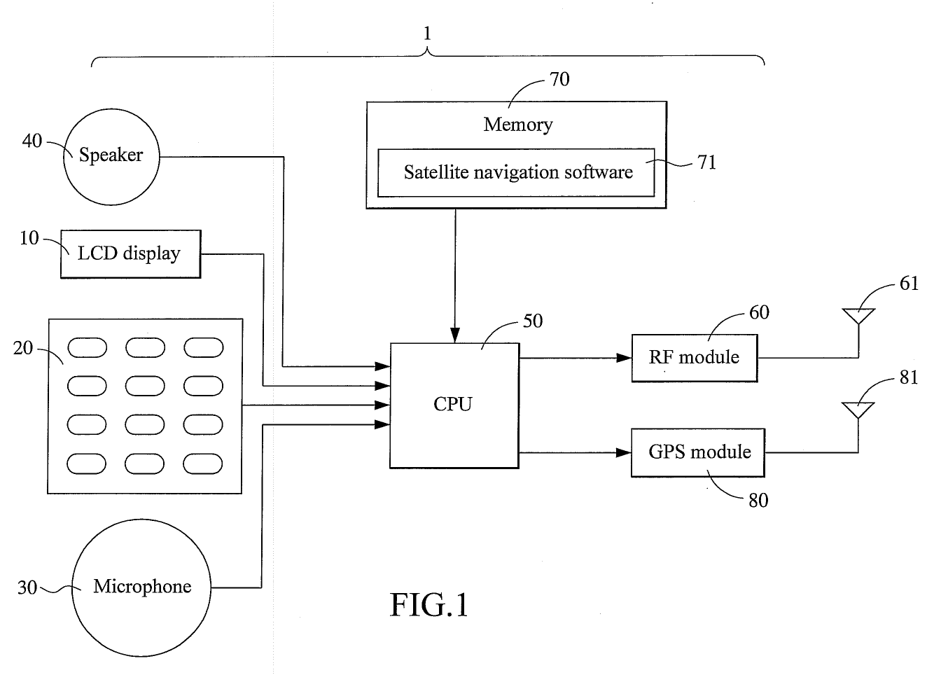

FIG. 1 is a block diagram of a mobile communication device 1 used in the present invention. The mobile communication device 1 may be a mobile phone, a personal digital assistant (PDA), or the like. The mobile communication device 1 includes a display 10, a keypad 20, a microphone 30, a speaker 40, a central processing unit 50, a radio frequency (RF) module 60, a memory 70, and a GPS module 80. The central processing unit 50 is electrically connected to the RF module 60, the memory 70, the GPS module 80, the display 10, the keypad 20, the microphone 30, and the speaker 40. The RF module 60 includes an RF antenna 61, while the GPS module 80 includes a GPS antenna 81. The memory 70 has satellite navigation software 71 installed therein for the mobile communication device 1 to drive and use the GPS module 80. The GPS antenna 81 receives satellite data to provide the current GPS coordinates of the mobile communication device 1.

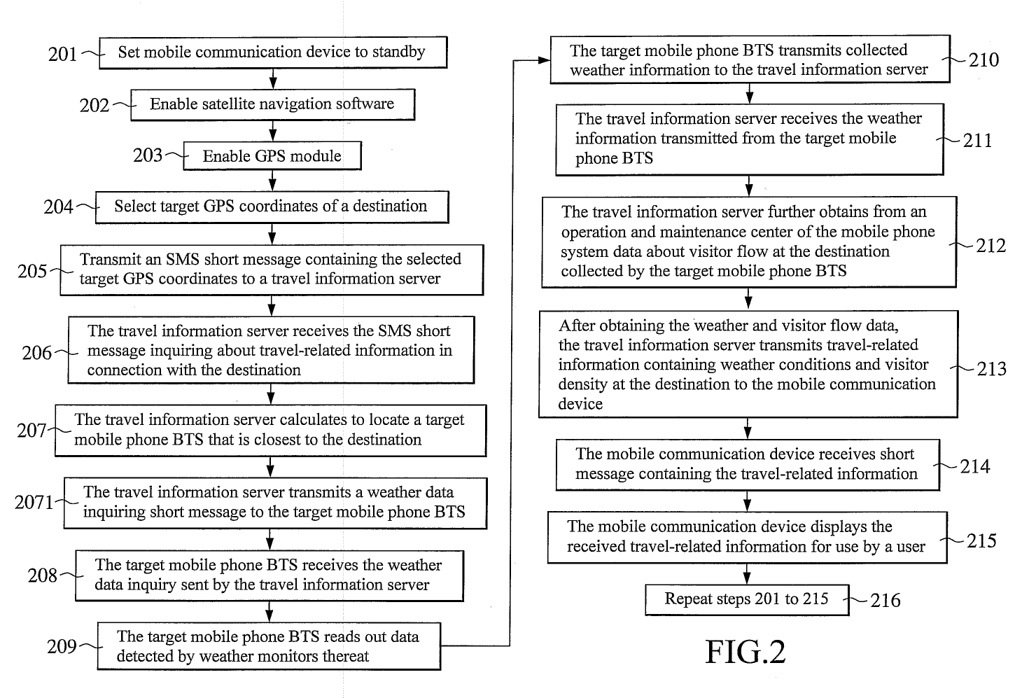

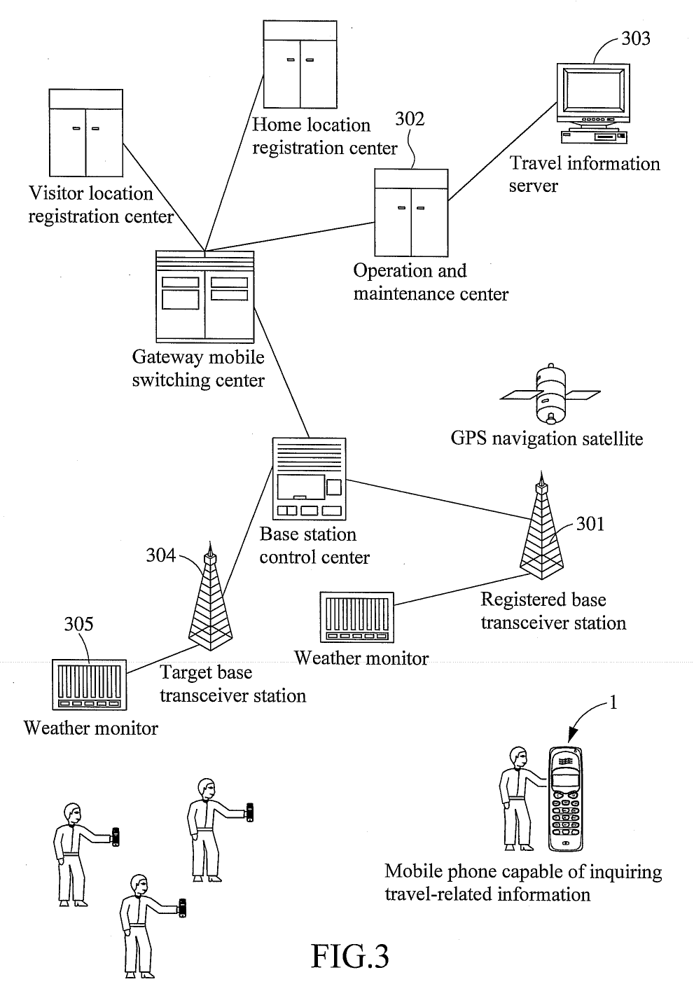

Please refer to FIG. 2 that is a flow chart showing the steps included in the method for inquiring real-time travel-related information using a mobile communication device according to the present invention, and to FIG. 3 that is a diagram showing the configuration of a mobile phone system applied in the present invention. Please refer to FIGS. 2 and 3 at the same time. The central processing unit 50 of the mobile communication device 1 follows the following steps to implement the method of the present invention.

In step 201, the mobile communication device 1 is set to a standby state.

In step 202, the satellite navigation software 71 in the memory 70 is enabled.

In step 203, the satellite navigation software 71 enables the GPS module 80. When being enabled, the GPS module 80 drives the GPS antenna 81 to continuously receive satellite positioning signals and update positioning data of the mobile communication device 1.

In step 204, a target GPS coordinates is selected. The target GPS coordinates are satellite navigation coordinate data of the position of a destination.

In step 205, via a registered mobile phone base transceiver station (BTS) 301, the mobile communication device 1 transmits an SMS short message to a travel information server 303 at an operation and maintenance center (OMC) 302 of a mobile phone system. The SMS short message contains the target GPS coordinates of the destination. For example, the SMS short message may be (0933123123 Travel Query: 121.0′3″ & 24.48′7″).

In step 206, the travel information server 303 receives the SMS short message inquiring about travel-related information in connection with the destination indicated by the target GPS coordinates.

In step 207, the travel information server 303 analyzes the received target GPS coordinates contained in the SMS short message and calculates to locate a target mobile phone BTS 304 that is closest to the target GPS coordinates.

In step 2071, the travel information server 303 transmits a weather data inquiring short message to the target mobile phone BTS 304.

In step 208, the target mobile phone BTS 304 receives the weather data inquiring short message from the travel information server 303.

In step 209, the target mobile phone BTS 304 reads out data detected and provided by weather monitors 305 at the target mobile phone BTS 304. The weather monitors 305 monitor and provide real-time weather information, including air quality, temperature, humidity, wind speed, wind direction, rain capacity, ultraviolet intensity, etc.

In step 210, the target mobile phone BTS 304 transmits the collected weather information to the travel information server 303.

In step 211, the travel information server 303 receives the weather information transmitted from the target mobile phone BTS 304.

In step 212, the travel information server 303 also obtains from the OMC 302 of the mobile phone system data about visitor flow at the destination corrected by the target mobile phone BTS 304, including the average number of mobile phones registered at the BTS, the current number of mobile phones registered at the BTS, the average visitor flow at the destination, the current visitor flow at the destination, etc., for use as real-time information about visitor density at the destination.

In step 213, when the visitor flow data mentioned in step 212 have been collected, the travel information server 303 transmits travel-related information to the mobile communication device 1, and the travel-related information contains the collected weather information and visitor density information in connection with the destination. For example, the travel-related information sent by the travel information server 303 may be as follows: “Weather: air quality/ordinary; temperature/39° C.; humidity/55%; wind speed/degree 2; wind direction/southwest; rain capacity/0 mm/hour; ultraviolet index/9. Visitors: average number of registered visitors/100; current number of registered visitors/300; average visitor flow/20 persons per hour; current visitor flow/5 persons per hour.”

In step 214, the mobile communication device 1 receives the short message of travel-related information containing the weather information and the visitor density information.

In step 215, the mobile communication device 1 displays the received travel-related information for use by a user.

And, in step 216, the steps 201 to 215 are repeated.

Since the present invention is established on an added function of an existing mobile phone communication system, and the mobile communication device with satellite navigation GPS function has become more and more popular, the present invention is practically feasible.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for inquiring real-time travel-related information using a mobile communication device 1, the mobile communication device 1 having satellite navigation software 71 installed therein to enable sending of a short message containing target GPS coordinates of a destination via a registered mobile phone base transceiver station (BTS) 301 to a travel information server 303 at an operation and maintenance center (OMC) 302 of a mobile phone system that provides short message service (SMS); and the travel information server 303 calculating based on the received target GPS coordinates to locate a target mobile phone BTS 304 that is closest to the target GPS coordinates, collecting real-time weather information dynamically detected and provided by weather monitors at the target mobile phone BTS 304; and transmitting the weather information along with separately collected visitor density information in connection with the destination to the mobile communication device 1; the method comprising the following steps:
(1) Setting the mobile communication device 1 to a standby state;
(2) Enabling the satellite navigation software 71 installed on a memory 70 in the mobile communication device 1;
(3) The satellite navigation software 71 enabling a GPS module 80 in the mobile communication device 1;
(4) A user of the mobile communication device 1 selecting target GPS coordinates of a destination;
(5) The mobile communication device 1 transmitting, via a registered mobile phone base transceiver station (BTS) 301, an SMS short message containing the selected target GPS coordinates of the destination to the travel information server 303 at the operation and maintenance center (OMC) 302 of the mobile phone system;
(6) The travel information server 303 receiving the SMS short message inquiring about travel-related information in connection with the destination;
(7) The travel information server 303 analyzing the target GPS coordinate of the destination contained in the received SMS short message, calculating to locate a target mobile phone BTS 304 that is closest to the destination;
(71) The travel information server 303 transmitting a weather data inquiring short message to the target mobile phone BTS 304;
(8) The target mobile phone BTS 304 receiving the weather data inquiry sent by the travel information server 303;
(9) The target mobile phone BTS 304 reading out data detected and provided by weather monitors 305 at the target mobile phone BTS 304;
(10) The target mobile phone BTS 304 transmitting collected weather information to the travel information server 303;
(11) The travel information server 303 receiving the weather information transmitted from the target mobile phone BTS 304;
(12) The travel information server 303 further obtaining from the OMC 302 of the mobile phone system data about visitor flow at the destination collected by the target mobile phone BTS 304;
(13) After obtaining the weather and visitor flow data, the travel information server 303 transmitting travel-related information containing weather conditions and visitor density at the destination to the mobile communication device 1;
(14) The mobile communication device 1 receiving the short message containing the travel-related information sent by the travel information server 303;
(15) The mobile communication device 1 displaying the received travel-related information for use by the user; and
(16) Repeating steps (1) to (15).
